(19) United States
(12) Patent Application Publication
(10) Pub. No.: US 2026/0136141 A1
(43) Pub. Date: May 14, 2026

(54) COMPRESSION METHOD FOR HEARING AIDS

(71) Applicant: LINEAR S.R.L., GENOVA (IT)

(72) Inventors: Lucio Giuseppe RACCA, GENOVA (IT); Matteo RACCA, MILANO (IT); Luca RACCA, GENOVA (IT); Roberto LUPO, ROMA (IT); Stefania REPETTO, BUSALLA (IT); Michele RICCHETTI, GENOVA (IT); Sara SANSALONE, GENOVA (IT)

(21) Appl. No.: 19/119,581

(22) PCT Filed: Oct. 13, 2023
(86) PCT No.: PCT/IT2023/050230

§ 371 Date: Apr. 9, 2025

(30) Foreign Application Priority Data
Oct. 20, 2022 (IT) 102022000021654

(51) Int. Cl. H04R 25/00

(52) U.S. Cl. CPC H04R 25/356; H04R 25/50

(57) ABSTRACT

A compression method for a hearing aid used by a hearing-impaired person is provided. The hearing aid comprises n frequency channels, each characterized by a linear gain and lower compression thresholds. The method determines compression parameters for each channel, including compression ratios, upper compression thresholds, and corresponding gains. For each channel, the upper compression threshold is set to the hearing-impaired person's annoyance threshold, adjusted by a parameter to convert from dB HL to dB SPL. The gain at the upper compression threshold is set to 0 dB. The compression ratio for each channel is calculated based on the linear gain, lower compression threshold, and annoyance threshold. The method allows for personalized compression settings tailored to the individual's hearing characteristics and comfort levels.

The invention relates to a fitting method for hearing aids. More in particular, it relates to a new method of customized compression on an audiological basis which can be conveniently employed to adjust hearing aids characterized by multi-channel non-linear amplification. Said method allows the widest dynamic range of sounds in input to be adapted to the residual hearing of the listener. Particularly, said method allows to amplify with compression sound components between the upper threshold of speech and the patient's annoyance threshold. Said annoyance threshold depends on the patient, the extent and type of deafness and changes along with the progress of the hearing aid fitting and further varying with the frequency of the sound stimulus.

### BACKGROUND ART

Almost all modern hearing aids use an algorithm called Dynamic Range Compression (DRC). It automatically adjusts the amplification to make weak sounds louder and loud sounds not as loud as they could be with a linear amplification system. Some twenty years ago, the focus was on determining the correct compression ratio in the hearing aid to adapt a very wide dynamic range of a normal ear to the reduced dynamic range of a compromised ear. Wide Dynamic Range Compression (WDRC) systems became the most popular prescriptive rule in modern hearing aids.

An assumption in most WDRC systems is that the entire audible intensity range must be compressed to adapt to the residual hearing of the hearing-impaired listener. In most WDRC systems, however, the compression is simply a way to avoid saturating the hearing aid. For this reason, no real customization can be carried out. Compressing the entire audible intensity range often leads to rather high compression values, in the case of severe or profound deafness, which imply greater signal distortion and worse listening quality for the patient. While on the one hand, compression can improve speech intelligibility because it places more speech within the listener's residual hearing, on the other hand it can increase distortion and worsen quality. Audibility and quality must both be safeguarded.

To achieve a good compromise between audibility and intelligibility, alternative and improved compression schemes can then be employed with respect to WDRC, taking into account that an effective compression scheme should be customized by means of the patient's audiological data (liminal hearing threshold and annoyance threshold) and be designed so as to appropriately compress the components beyond the upper speech threshold up to the person's annoyance threshold. It will thereby be as optimal as possible for that specific patient and will appropriately compress the dynamic components between the upper speech threshold and the annoyance threshold; said components being for example associated with music, alarms, sirens whose signals are typically characterized by excessive dynamics, but need due attention both for acoustic comfort and for the protection of patients.

Traditional WDRC systems typically set the lower threshold value of the compression system to 40 dB SPL and set the upper threshold value to 100 dB SPL. Furthermore, said systems set a maximum output power of the hearing aid (MPO) at 100 dB SPL for any input signal greater than 100 dB SPL and are not customized according to the patient's residual hearing.

From the patent point of view, attempts to make alternative and improved compression schemes with respect to said WDRC scheme are known. A hearing aid with improved and alternative compression scheme to said WDRC is discussed in US 2013/0102923 A1. Here, in order to reduce distortion while maintaining audibility, the authors propose adapting to the impaired ear only the dynamic range of speech, rather than the entire dynamic range of a normal ear, and measuring the residual hearing of the listener in situ. The range of speech in said patent is arbitrarily set between 50 and 85 dB SPL and the residual dynamic of the listener is established based on in situ measurements of liminal hearing threshold and annoyance threshold. Although improved with respect to said WDRC scheme because it is customized, such a system sets a maximum output power of the apparatus (MPO) equal to the listener's annoyance threshold, for any sound in input exceeding 85 dB SPL, therefore not optimized for sounds of intensity exceeding the upper speech threshold, for example music, alarms, sirens and the like. An improved compression scheme designed to ensure minimum compression and give the best compromise between audibility and intelligibility also in response to changes in the input signal is that discussed in EP 2 658 120 A1. It is a compression scheme capable of adapting to any variation in amplitude of the sound in input. Here, the authors propose to adapt the dynamic range of the sound signal in input to the compromised ear, whatever it may be. The dynamic range of the signal to be compressed according to said patent is arbitrarily set between 50 and 80 dB SPL and the compression to be applied is modified almost in real time by means of an analysis of the minimum and maximum of the sound signal in input. Signals of intensity exceeding the upper speech threshold (associated for example with music, alarms, sirens . . . ) are therefore also amplified with compression, without limiting them to the MPO value as typically occurs in WDRC systems and particularly in US 2013/0102923 A1.

According to said systems, the quality of such signals is drastically reduced and therefore the patient's sensitivity related to the type of associated sounds is very compromised. Patent EP 2 658 120 A1, although improved, nevertheless requires a continuous updating of the compression during the normal operation of the hearing aid and most hearing aids, present on the market, do not have this functionality.

Although both compression schemes disclosed in US 2013/0102923 A1 and in EP 2 658 120 A1 are alternative and improved with respect to the aforementioned systems based on WDRC scheme in terms of fitting customization, the determination of the residual hearing of the listener based on the measurement of the annoyance threshold by means of supraliminal tonal audiometric examination can lead to even significant inaccuracies if the subject has, for example, cognitive deficits even of a minor nature, but such as to render the outcome of the test unreliable which requires, to be carried out, the direct involvement of the patient who must typically respond to acoustic stimuli by raising their hand or pressing a button. Such an examination is used for both of the aforesaid compression schemes described in US 2013/0102923 A1 and EP 2 658 120 A1. Further known are patents EP 2 823 853 A1 and US 2013/044889 A1.

In EP 2 823 853 A1, the authors describe an acoustic signal processor, for auditory devices, which exceeds the limits of processing systems with audio compression, often causing artefacts in the processed acoustic signal and no improvement in speech intelligibility. The hearing device referred to in EP 2 823 853 A1 is for the electrical stimulation of auditory neural fibres. In EP 2 823 853 A1, the authors propose to adapt the dynamic range of the sound signal in input to the compromised ear, whatever it may be; the acoustic perception varies from person to person and the hearing aid must therefore be calibrated. The dynamic range of the signal to be amplified with appropriate gain, according to said patent, is not fixed a priori, but is characterized by a lower end, Lt, an upper end, Lc, and an intermediate level, Lk, comprised between Lt and Lc. Furthermore, said patent in EP 2 823 853 A1 sets the gain, for sounds of intensity comprised between LT and Lk, higher than the set gain for sounds whose intensity is higher than Lk and lower than Lc. Although the intermediate level Lk is variable, and said variability of the input dynamic range allows to optimize the dynamic components of intensity higher than Lk and lower than Lc, it is still true that such variability is a function of objective analysis of the input acoustic signal through statistical evaluation of some linguistic contexts or of indications provided based on the preferences of the patient himself, therefore potentially unsure, if the subject has, for example, even slight cognitive deficits, a condition which often accompanies the status of frail elderly.

In patent US 2013/044889 A1 the authors propose a solution to the still open challenge of giving patients with reduced auditory dynamics the widest possible range of sounds, trying to maximize intelligibility and give good listening quality. In US 2013/044889 A1 the authors present a method based on controlling the modulation depth of the output electrical signal, which must be kept lower than that of the input electrical signal, to ensure acoustic comfort and protect patients with reduced auditory dynamics, monitoring the effects of the compression amplification algorithm and using the result to influence or control the algorithm (combined feed-forward and feed-back control method). Although a configuration of the controller is also provided which defines a predefined target modulation, on an audiological basis, which can be modified over time to better adapt to the reduced dynamics of the patient, the fact remains that the identification of this target modulation is not clarified in US 2013/044889 A1, suggesting the use of subjective measures, with the previously listed limits of imprecision and unreliability.

Further known are WO2019220336A1 and the article published in Van Buuren's JASA Ronald A. et al “Compression and expansion of the temporal envelope: Evaluation of Speech intelligibility and Sound Quality”.

An improved alternative for a more reliable detection of the annoyance threshold which cannot be affected by any cognitive deficits of the patient is provided in the compression scheme proposed in the present invention and is based on the measurement of the contralateral stapedial reflex associated with the contraction of the stapedius muscle by means of impedance examination.

Returning the widest possible dynamic range of signals to a patient with reduced hearing dynamics, ensuring audibility, intelligibility and good listening quality still remains a major challenge for any fitting method for hearing aids.

In particular, the listening quality that most non-linear hearing aids can ensure for sounds in input characterized by intensities exceeding the threshold above speech continues to be critical and not optimal, such as music, alarms, sirens and the like, i.e., sounds which can typically exceed 80-85 dB SPL, without having to resort to dedicated hardware. The method of the present invention allows to amplify with compression the aforesaid sound components between said upper speech threshold and said patient annoyance threshold, for any hearing aid without the need for dedicated hardware.

### OBJECTS OF THE INVENTION

It is an object of the present invention to propose a new compression amplification method for non-linear and multi-channel hearing aids, said method being improved and alternative with respect to those present in the background art.

More particularly, it is an object of the present invention to amplify with compression sound components between the upper speech threshold and the patient's annoyance threshold; said annoyance threshold varying from person to person and depending on the hearing loss and on the course of the fitting faced by the patient and further varying with the frequency of the sound stimulus received.

Said dynamic sound components exceeding the upper speech threshold, that is, over 80-85 dB SPL, are important for ensuring a complete acoustic experience for the listener with hearing problems, which does not penalize the sound components which are different from speech and of higher intensity; said sound components typically being associated with significant acoustic signals such as music, alarms, sirens and the like.

The method of the present invention allows to obtain a customized listening completeness, taking into account the listener's own annoyance threshold and optimizing the sound components close to said annoyance threshold.

The aforesaid sound components, beyond the upper speech threshold up to the patient annoyance threshold, are still the most critical to be treated today. An optimal amplification of said components, by means of compression, would allow the patient to be able to hear in the best way even those sounds whose intensity is close to the patient annoyance threshold.

### BRIEF DISCLOSURE OF THE INVENTION

The present invention intends to propose a compression method for multi-channel non-linear hearing aids capable of amplifying with compression the aforesaid dynamic components between the upper speech threshold and the patient's annoyance threshold, without the need for dedicated hardware, ensuring for the patient with hearing problems a quality, complete and customized acoustic experience. Said acoustic experience being obtained by means of a method which does not penalize the components exceeding the upper speech threshold; said method allowing to overcome the known limits of the WDRC systems currently used. Said method being characterized by a compression which is a function of the patient's annoyance threshold which allows to optimize dynamic components in input located between the upper speech threshold (typically in the region of 80 dB SPL) and the patient's annoyance threshold such as music, alarms, sirens and the like.

In particular, the method envisages extending, as a function of the annoyance threshold perceived by the patient, the zone of amplification with compression of the hearing aid.

Said widening of the dynamic range in input allowing to optimize the dynamic components of intensity above the upper speech threshold.

Furthermore, the proposed method sets the gain at the upper end of said enlarged range at a value equal to 0 dB; this allows to avoid possible damage to the patient's cochlea at the aforementioned dynamic components above the upper speech threshold up to the patient's annoyance threshold.

Said annoyance threshold being determined according to the method through a series of alternatives based on stapedial reflex measurements or voice audiogram.

### BRIEF DESCRIPTION OF THE ACCOMPANYING DRAWINGS

Further characteristics and advantages of the proposed technical solution will appear more evident in the following description of a preferred, but not exclusive, embodiment represented in the no. 5 accompanying drawing tables, wherein:

FIG. 1 illustrates the use diagram of the method proposed according to the invention;

FIG. 2 illustrates a typical compression scheme according to the well-known WDRC system;

FIG. 3 shows the compression scheme proposed and applied according to the invention at an n-th frequency channel;

FIG. 4 illustrates the main steps of the method according to the invention;

FIGS. 5a, 5b and 5c illustrate three different implementation alternatives proposed by the method for estimating the annoyance threshold Fn starting from the measurement of the contralateral stapedial reflex of the hearing-impaired patient;

FIG. 6 shows an implementation alternative proposed by the method to estimate the patient's annoyance threshold Fn starting from the patient's average liminal hearing threshold, PTA, from the threshold Fs where speech intelligibility is maximum and from the threshold D where speech intelligibility is 0%;

FIG. 7 represents the value of βn for a non-linear hearing aid characterized by n=8 frequency channels;

FIG. 8 shows a voice audiogram example of a hearing-impaired patient and shows the threshold Fs where speech intelligibility is maximum and the threshold D where speech intelligibility is 0%;

FIG. 9 shows an example of a tonal audiogram of a hearing-impaired patient and shows the patient's liminal hearing threshold expressed in dB HL in each frequency channel of a hearing aid characterized by n=8 frequency channels.

### BEST WAY TO CARRY OUT THE INVENTION

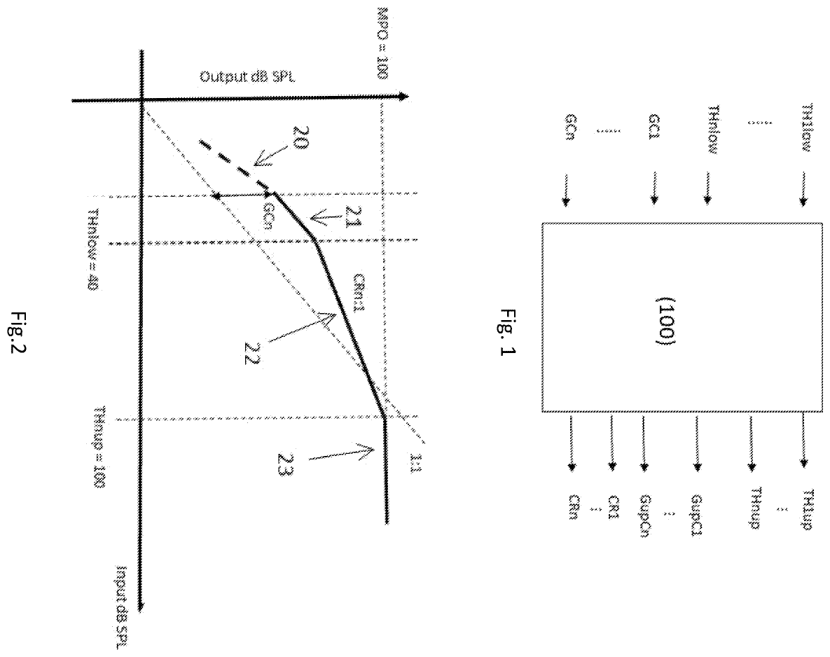

With reference to the accompanying drawings, and particularly to FIG. 1, the typical use of the method according to the proposed invention is illustrated. In particular, the method (100) allows to set the compression amplification of hearing aids equipped with up to n frequency channels: [C1, C2 . . . Cn]; each of said n frequency channels being characterized by a linear amplification zone with gain [GC1, GC2, . . . , GCn)]; said linear amplification zone extending up to a first threshold known as the lower compression threshold [(TH1low, TH2low, . . . THnlow] beyond which the signal is amplified with compression.

The proposed method (100) allows to process the aforesaid gains [GC1, GC2, . . . , GCn)] and the aforesaid lower compression thresholds [(TH1low, TH2low, . . . THnlow] and allows to determine for each of said n frequency channels [C1, C2 . . . Cn] the corresponding compression ratios (CR1, CR2, . . . , CRn), the corresponding upper compression thresholds [(TH1up, TH2up, . . . THnup] and, furthermore, allows to set the gains corresponding to said upper compression thresholds [GupC1, GupC2, . . . GupCn].

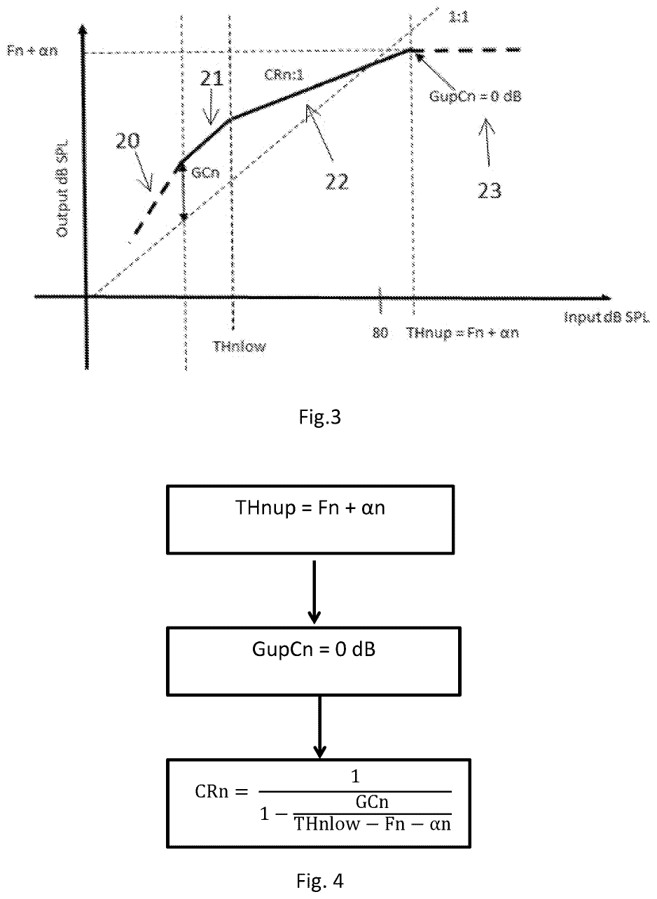

The aforementioned parameters are commonly employed by a hearing care professional to program and particularly adjust the amplification of a multi-channel non-linear hearing apparatus. With reference to the accompanying drawings and particularly to FIG. 2 and FIG. 3, a comparison between the compression scheme of a typical commercial WDRC system and the compression scheme according to the proposed method (100) is illustrated.

Typically, a non-linear hearing aid is characterized by what is known as an expansion zone (20), a linear amplification zone (21) and a compression zone (22) and by a further zone which is known as an output limiting zone (23).

The proposed method (100) allows to set the parameters which define the operation of the hearing aid in said compression zone (22). In particular, said FIG. 2 and FIG. 3 show the different settings of the upper compression threshold THnup for a frequency channel of a non-linear hearing aid. Further illustrated is the different compression amplification applied to signals with intensity exceeding the lower compression threshold THnlow. In particular, FIG. 2 it is observed that the lower compression threshold THnlow in WDRC systems is typically set to 40 dB SPL while the upper compression threshold THnup is set to 100 db SPL, regardless of the patient's annoyance threshold or an estimate thereof. Furthermore, according to said WDRC systems, any signal in input exceeding the upper threshold THnup equal to 100 db SPL is amplified so as not to exceed the maximum power output MPO of the apparatus. Said maximum power in most commercial hearing aids is typically set at 100 db SPL in order to avoid saturation of the hearing aid itself without due regard to the patient annoyance threshold. Contrary to the previously mentioned patents, the method presented in this patent proposes to not limit the maximum power output (MPO) allowing the hearing aid to have a greater dynamic range also in consideration of the low probability/recurrence of high intensity sounds.

With reference to the accompanying drawings, and particularly to FIG. 3, the solution approach proposed by the method (100) referred to in the invention is shown. In particular, the compression scheme is shown, applying said proposed method according to the invention to an n-th frequency channel; said channel being characterized by linear gain GCn and by a lower compression threshold THnlow. The upper compression threshold THnup is determined according to the proposed method as a function depending on the annoyance or an estimate of the annoyance perceived by the patient and is set to the value of:

$$THnup = Fn + α n$$

where Fn is the patient annoyance threshold, said threshold being measured by supraliminal tonal audiometric examination or computed according to a plurality of estimation methods and αn is a parameter dependent on the nth frequency channel and is used to convert Fn from dB HL to dB SPL.

Always in reference to FIG. 3 of the accompanying drawings, it is observed that according to the proposed method (100), any signal in input of intensity comprised between the upper speech threshold, typically in the region of 80 dB SPL, and the patient's annoyance threshold THnup is amplified with compression so as not to exceed an output power equal to the patient's annoyance threshold, Fn+αn dB SPL. The proposed method is therefore characterized by compressing a dynamic range of inputs [Thnlow; Fn+αn] variable as a function of the annoyance; this allows to optimize the dynamic components above the typical upper speech threshold of 80 db SPL up to the annoyance threshold.

Furthermore, the gain at said upper threshold Thnup=Fn+αn is set according to the method at a value equal to 0 dB; this allows to avoid possible damage to the patient's cochlea at the aforementioned dynamic components above the typical upper speech threshold of 80 dB SPL. As for the dynamic components which exceed the upper compression threshold Thnup=Fn+αn, i.e., the components located in the aforementioned output limiting zone (23), it is observed that said components are processed so that the output of the hearing aid does not exceed the patient annoyance threshold established according to the method and equal to Fn+αn. With reference to the accompanying drawings and particularly to FIG. 4, the main steps of the method (100) according to the invention are illustrated which allow the compression scheme indicated in FIG. 3 to be carried out. In particular, it can be seen that for one of the aforesaid frequency channels, Cn, characterized by a lower compression threshold THnlow and a linear gain GCn, the following steps are performed:
the first step sets the upper threshold THnup equal to the threshold of the hearing-impaired person's annoyance expressed in dB SPL as

$$THnup = Fn + α n ,$$

where αn is a parameter dependent on the frequency channel Cn and is used to convert Fn from dB HL to dB SPL;
in the second step, the gain at said upper threshold THnup is set to 0 dB,

$$GupC {n}_{THnup} = 0 dB ;$$

in the third step, the compression ratio CRn is calculated according to the following formula:

$$CRn = \frac{1}{1 + \frac{( GupC {n}_{THnup} - G Cn )}{( ( THnlow ) - ( THnup )}}$$

in which replacing the parameters THnup and GupCn_{THnup} in the previous steps becomes:

$$CRn = \frac{1}{1 - \frac{GCn}{THnlow - F n - α n}}$$

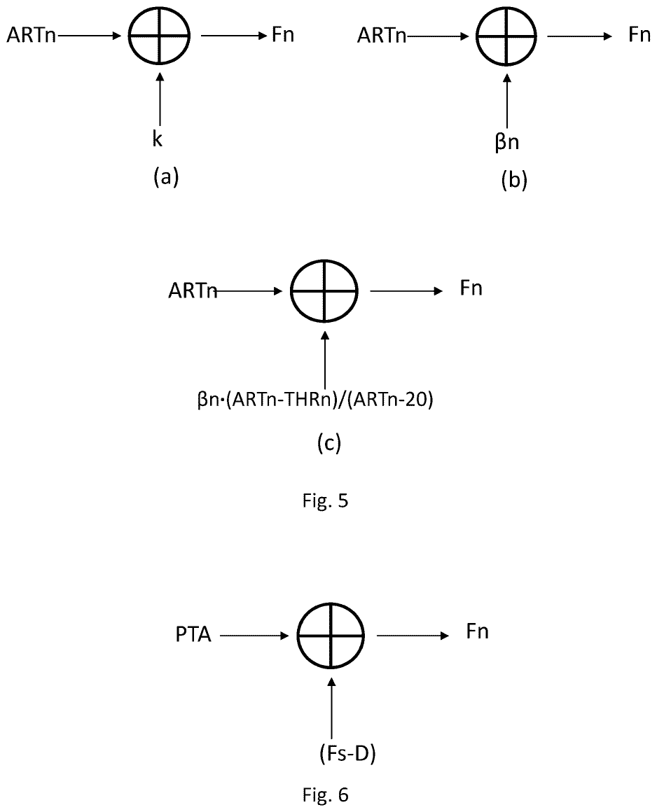

With reference to the accompanying drawings and particularly to FIG. 5 three modes for estimating the annoyance threshold Fn are illustrated as an alternative to performing a supraliminal tonal audiometric examination. Said methods using an estimate of the annoyance Fn obtained from the measurement of the contralateral stapedial reflex ARTn, said measurement ARTn being associated with the contraction of the stapedius muscle of the hearing-impaired patient and being obtained by impedance examination; this without the need for said patient to provide any feedback. Patient feedback which can notoriously be altered and above all affected by the cognitive and/or emotional state thereof.

With reference to the accompanying drawings, and particularly to FIG. 5a, an estimate of the annoyance threshold is determined according to the proposed method (100) and is calculated as

$$Fn = ARTn + K$$

where ARTn is the measurement of the contralateral stapedial reflex obtained by means of impedance examination on the hearing-impaired patient and K is the average deviation in frequency between reflex and annoyance in a normally-hearing person and is calculated as follows:

$$K = \frac{1}{n} \cdot {\sum }_{n} β n$$

According to an exemplary embodiment, the deviation between reflex and annoyance in a normally-hearing person can be evaluated at the frequencies 125 Hz, 250 Hz, 500 Hz, 1 kHz, 2 KHz, 4 kHz, 8 KHz and the average value of said values, k, is set at a value equal to 15. With reference to the accompanying drawings, and particularly to FIG. 5b, an estimate of the annoyance threshold is determined according to the proposed method (100) and is calculated as

$$Fn = ARTn + β n$$

where ARTn is the measurement of the contralateral stapedial reflex obtained by means of impedance examination on the hearing-impaired patient and βn is the deviation between reflex and annoyance of a normally-hearing person for the nth frequency channel Cn.

With reference to the accompanying drawings, and particularly to FIG. 5c, an estimate of the annoyance threshold is determined according to the proposed method (100) and is calculated as

$$Fn = ARTn + β n \cdot \frac{( A R T n - T H R n )}{( A R T n - 20 )}$$

where ARTn is the measurement of the contralateral stapedial reflex obtained by means of impedance examination on the hearing-impaired patient, βn is the deviation between reflex and annoyance of a normally-hearing person for the nth frequency channel Cn, THRn is the liminal hearing threshold of the patient in said channel Cn.

With reference to the accompanying drawings and particularly to FIG. 6 shows a method for estimating the annoyance threshold Fn, an alternative to the supraliminal tonal audiometric examination and an alternative to the three methods illustrated in FIG. 5.

The three modes illustrated in FIG. 5 employ an estimate of annoyance derived from the measurement of the contralateral stapedial reflex, associated with the contraction of the stapedius muscle which, in some cases, however, may not be present.

The absence of the stapedial reflex can be associated with severe bilateral neurosensory deafness (liminal hearing threshold greater than 80 dB HL), but it can also be due to multiple factors such as the presence of a spill in the tympanic cavity, the presence of otosclerosis, since the stirrup, blocked in the oval window does not allow the variation of impedance necessary for the correct transduction of sound by the middle ear, a disruption of the ossicular chain at the anvil or hammer level (the other two ossicles which together with the stirrup constitute the ossicular chain of the middle ear) and finally the absence of the stapedial muscle. The annoyance estimation mode shown in FIG. 6 is therefore not based on the measurement of the stapedial reflex, but allows to determine an estimate of the annoyance Fn with the following formula

$$Fn = PTA + ( Fs - D )$$

where PTA is the average liminal hearing threshold of the hearing-impaired patient and is typically calculated as the average of the tonal liminal hearing thresholds at the frequencies 500 Hz, 1 kHz, 2 kHz; where Fs is the threshold where speech intelligibility is highest and D is the threshold where speech intelligibility is 0%; said thresholds Fs and D being obtained by vocal audiometry on the patient.

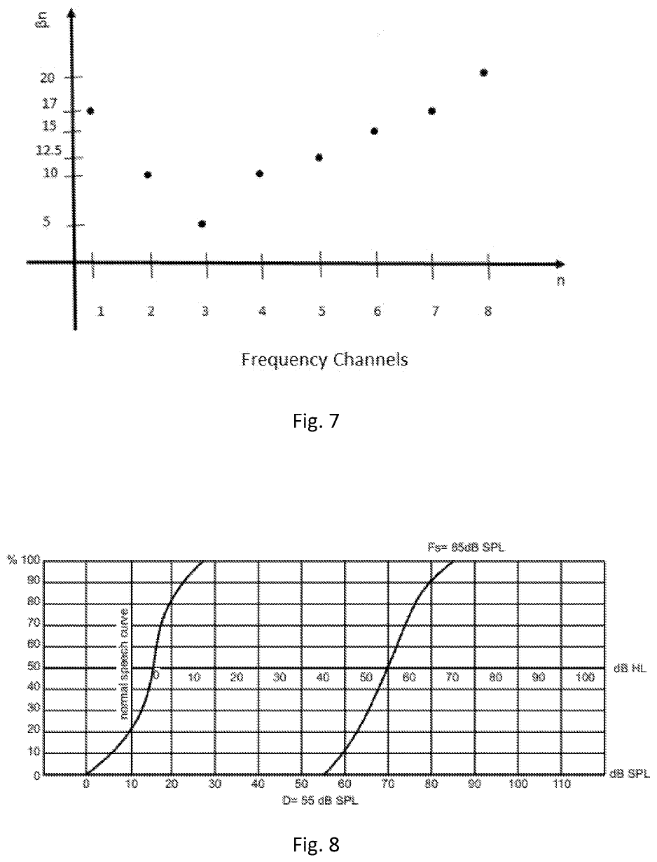

With reference to the accompanying drawings and particularly to FIG. 7 shows a mode of assigning the parameter βn, i.e., the deviation between reflex ARTn and annoyance Fn for a normally-hearing person in the n-th frequency channel Cn. Said parameter βn being used to obtain the estimate of the annoyance Fn according to the implementation alternatives referred to in the previous FIG. 5b and FIG. 5c. In particular, FIG. 7 report by way of non-limiting example the example of a non-linear hearing aid characterized by n=8 frequency channels. As can be observed, βn is not constant, but has a variable trend with the n-th channel. Typically, βn assumes maximum values at the extremes and a minimum value for n=3; said minimum value corresponding, depending on the number of channels characterizing the apparatus, to the frequencies located around 1 kHz.

With reference to the accompanying drawings and particularly to FIG. 8, an example of a voice audiogram is shown; said audiogram allowing to determine the aforementioned thresholds Fs and D used to estimate the annoyance threshold Fn according to the implementation alternative previously shown in FIG. 6. In this example the patient's threshold D, where the intelligibility of speech is 0%, is equal to 55 db SPL and this means that when the patient is presented with sound stimuli, typically a list of words of said intensity, the patient correctly repeats 0% of the words. Still in the exemplary embodiment of FIG. 8 the threshold Fs, where the speech intelligibility is maximum, is 85 dB SPL. This means that, when the patient is presented with sound stimuli of said intensity, the patient repeats the maximum percentage of words received. In the embodiment of FIG. 8 this maximum percentage is equal to 100%, but could also take on different values depending on the deafness of the patient and the presence or absence of ear diseases and/or the patient's cognitive status.

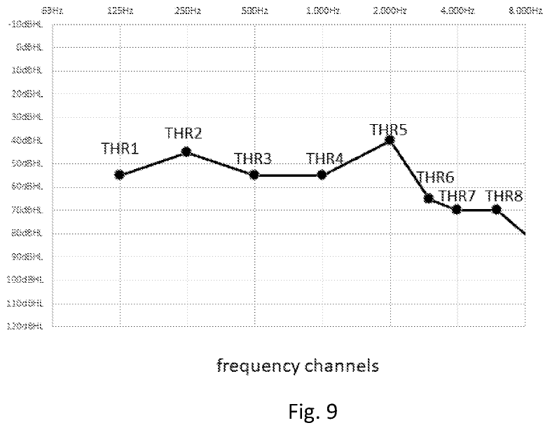

With reference to the accompanying drawings and particularly to FIG. 9, an example of a tonal audiogram performed on the patient in order to program a non-linear hearing aid characterized by a number of n=8 frequency channels is given by way of non-limiting example. Said tonal audiogram representing the liminal hearing threshold THRn measured by tonal audiometric test; said threshold THRn being used to estimate the annoyance Fn according to the implementation alternative previously shown in FIG. 5c.

### INDUSTRIAL APPLICABILITY

The method (100) according to the invention allows a hearing care professional to program a hearing aid so that the compression amplification region is variable as a function of the patient's annoyance threshold and allows to optimize dynamic input components between the upper speech threshold, typically in the region of 80 dB SPL, and the patient's annoyance threshold such as music, alarms, sirens and the like. Said dynamic components require due attention both for acoustic comfort and for the protection of the hearing-impaired patient. Said dynamic components are still the most critical to amplify in most hearing aids today, as they are close to the patient annoyance threshold. Said annoyance threshold depends on the patient, the extent and type of deafness and changes along with the progress of the hearing aid fitting and further varying with the frequency of the sound stimulus. The method according to the invention allows said dynamic components to be amplified with compression beyond the upper speech threshold up to the patient annoyance threshold and is conveniently applied to any multi-channel non-linear hearing aid without the need for additional or dedicated hardware. With the method (100) according to the invention, the hearing care professional is capable of optimizing the amplification of dynamic components close to the patient's annoyance threshold, whatever they may be. In the case of hearing aids with more than one memory programmed for listening, the compression amplification method according to the invention can be employed in each of the aforesaid memories, ensuring a compression amplification of the dynamic components exceeding the upper speech threshold up to the patient's annoyance threshold, in response to any variation of the signal in input, in any situation in which the hearing aid is operating.

While the invention is subject to various modifications and alternative constructions, some preferred embodiments have been shown in the drawings and described in detail in the preceding paragraphs. It should be understood, however, that there is no intention to limit the invention to the specific illustrated embodiment but, on the contrary, the aim is to cover all the modifications, alternative constructions and equivalents falling within the scope of the invention as defined in the attached claims. The use of “for example”, “etc.”, “or”, “preferably” refers to non-exclusive non-limiting alternatives, unless otherwise stated.

In particular, the invention can be implemented on technical equivalent devices, with supplementary techniques or solutions suitable for the purpose and the application scope.

Conformation and dimensions of the constituent parts of the multi-channel linear hearing aid object of the method may suitably vary, but in a manner consistent with the proposed technical solution and without affecting the validity thereof.

In any case, said necessary modifications to the method object of the invention and, particularly to its characterizing elements, will be adapted to each installation, to the hardware and to the specific needs and pathologies, appropriately varying the procedures, but they can be deduced by a suitably trained person skilled in the art and without departing from the scope of protection of the claimed patent.

Particularly the method may be further employed to be applied to functionally equivalent devices such as cochlear implants, bone conduction devices and, more generally, in the context of electronic systems for the compression processing of audio signals. Lastly, the applicant reserves and claims the right to protection on the proposed method (100) even if partially implemented.

1-6. (canceled)

7. A compression method for a hearing aid for use by a hearing-impaired person, comprising:
providing the hearing aid, wherein the hearing aid comprises n frequency channels [C1, C2, . . . , Cn], each of the frequency channels being characterized by a linear gain [GC1, GC2, . . . , GCn)] and lower compression thresholds [(TH1low, TH2low, . . . , THnlow];
determining compression parameters of each of the n frequency channels [C1, C2, . . . , Cn], the compression parameters comprising compression ratios (CR1, CR2, . . . , CRn), upper compression thresholds [(TH1up, TH2up, . . . , THnup], and gains [GupC1, GupC2, . . . , GupCn] corresponding to the upper compression thresholds [(TH1up, TH2up, . . . , THnup]; and
for each channel Cn, setting the upper compression threshold THnup of the hearing aid to an annoyance threshold Fn for the hearing-impaired person based at least in part on: THnup=Fn+αn, where αn is a parameter for converting Fn from dB HL to dB SPL,
wherein, for each channel Cn, the gain GupCn at the upper compression threshold THnup is based at least in part on: GupCn_{THnup}=0 dB; and
wherein, for each channel Cn, the compression ratio CRn is based at least in part on:
$$CRn = \frac{1}{1 - \frac{GCn}{THnlow - F n - α n}} .$$

8. The compression method according to claim 7, further comprising determining the annoyance threshold Fn of the hearing-impaired person based at least in part on: Fn=ARTn+βn, where ARTn is a contralateral stapedial reflex obtained by performing an impedance examination on the hearing-impaired person, and βn is a deviation between the contralateral stapedial reflex and an annoyance threshold of a normal-hearing person.

9. The compression method according to claim 7, wherein the annoyance threshold Fn of the hearing-impaired person is determined according to the following formula:
$$F n = A R T n + β n \cdot \frac{( A R T n - T H R n )}{( A R T n - 20 )}$$
where ARTn is a contralateral stapedial reflex obtained by performing an impedance examination on the hearing-impaired person, THRn is a liminal hearing threshold obtained by performing a tonal liminal audiometry on the hearing-impaired person, and βn is a deviation between the contralateral stapedial reflex and an annoyance threshold of a normally-hearing person.

10. The compression method according to claim 7, wherein the annoyance threshold Fn of the hearing-impaired person is determined according to the following formula: Fn=ARTn+K, where ARTn is a contralateral stapedial reflex obtained by performing an impedance examination on the hearing-impaired person and parameter K is determined according to the following formula:
$$K = \frac{1}{n} \cdot {\sum }_{n} β n ,$$
where βn is a deviation between the contralateral stapedial reflex and an annoyance threshold of a normally-hearing person.

11. The compression method for hearing aids according to claim 10, wherein the parameter K is 15 dB.

12. The compression method according to claim 7, wherein the annoyance threshold Fn of the hearing-impaired person is determined by: Fn=PTA+(Fs−D), where Fs is a threshold where speech intelligibility is highest and D is a threshold where speech intelligibility is 0%, wherein thresholds Fs and D are obtained by performing vocal audiometry on the hearing-impaired person, and PTA is an average liminal hearing threshold of the hearing-impaired person obtained by performing tonal liminal audiometry.

13. A system for implementing a compression method in a hearing aid for a hearing-impaired person, the system comprising:
a hearing aid comprising n frequency channels [C1, C2, . . . , Cn], each frequency channel being characterized by a linear gain [GC1, GC2, . . . , GCn] and lower compression thresholds [(TH1low, TH2low, . . . , THnlow]; and
a processor configured to:
determine compression parameters for each of the n frequency channels, the compression parameters comprising compression ratios (CR1, CR2, . . . , CRn), upper compression thresholds [(THlup, TH2up, . . . , THnup], and gains [GupC1, GupC2, . . . , GupCn] corresponding to the upper compression thresholds;
for each channel Cn, set the upper compression threshold THnup to an annoyance threshold Fn for the hearing-impaired person based at least in part on: THnup=Fn+αn, where αn is a parameter for converting Fn from dB HL to dB SPL;
for each channel Cn, set the gain GupCn at the upper compression threshold THnup based at least in part on: GupCnTHnup=0 dB; and
for each channel Cn, determine the compression ratio CRn based at least in part on: CRn=1/(1−GCn/(THnlow−Fn−αn)).

14. The system of claim 13, wherein the processor is further configured to determine the annoyance threshold Fn of the hearing-impaired person based at least in part on: Fn=ARTn+βn, where ARTn is a contralateral stapedial reflex obtained by performing an impedance examination on the hearing-impaired person, and βn is a deviation between the contralateral stapedial reflex and an annoyance threshold of a normal-hearing person.

15. The system of claim 13, wherein the processor is further configured to determine the annoyance threshold Fn of the hearing-impaired person based at least in part on: Fn=ARTn+βn−((ARTn−THRn)/(ARTn−20)), where ARTn is a contralateral stapedial reflex obtained by performing an impedance examination on the hearing-impaired person, THRn is a liminal hearing threshold obtained by performing a tonal liminal audiometry on the hearing-impaired person, and βn is a deviation between the contralateral stapedial reflex and an annoyance threshold of a normally-hearing person.

16. The system of claim 13, wherein the processor is further configured to determine the annoyance threshold Fn of the hearing-impaired person based at least in part on: Fn=ARTn+K, where ARTn is a contralateral stapedial reflex obtained by performing an impedance examination on the hearing-impaired person and K is a parameter determined according to: K=(1/n)Σ(βn), where βn is a deviation between the contralateral stapedial reflex and an annoyance threshold of a normally-hearing person.

17. The system of claim 16, wherein the parameter K is 15 dB.

18. The system of claim 13, wherein the processor is further configured to determine the annoyance threshold Fn of the hearing-impaired person based at least in part on: Fn=PTA+(Fs−D), where Fs is a threshold where speech intelligibility is highest and D is a threshold where speech intelligibility is 0%, wherein thresholds Fs and D are obtained by performing vocal audiometry on the hearing-impaired person, and PTA is an average liminal hearing threshold of the hearing-impaired person obtained by performing tonal liminal audiometry.

19. A fitting method for hearing aids, comprising:
determining an annoyance threshold Fn for a hearing-impaired person;
setting an upper compression threshold THnup of a hearing aid for each of n frequency channels of the hearing aid based at least in part on the annoyance threshold Fn;
setting a gain GupCn at the upper compression threshold THnup for each frequency channel of the hearing aid;
determining a compression ratio CRn for each frequency channel based at least in part on the upper compression threshold THnup and a lower compression threshold THnlow; and
programming the hearing aid with the determined upper compression thresholds, gains, and compression ratios for each frequency channel.

20. The fitting method of claim 19, wherein determining the annoyance threshold Fn comprises performing an impedance examination to obtain a contralateral stapedial reflex ARTn of the hearing-impaired person.

21. The fitting method of claim 20, wherein determining the annoyance threshold Fn further comprises calculating Fn based at least in part on the contralateral stapedial reflex ARTn and a deviation βn between the contralateral stapedial reflex and an annoyance threshold of a normally-hearing person.

22. The fitting method of claim 19, wherein determining the annoyance threshold Fn comprises performing a vocal audiometry to obtain a threshold Fs where speech intelligibility is highest and a threshold D where speech intelligibility is 0% for the hearing-impaired person.

23. The fitting method of claim 22, wherein determining the annoyance threshold Fn further comprises performing a tonal liminal audiometry to obtain an average liminal hearing threshold PTA of the hearing-impaired person.

24. The fitting method of claim 19, wherein setting the upper compression threshold THnup comprises adding a parameter αn to the annoyance threshold Fn, where αn converts Fn from dB HL to dB SPL.

25. The fitting method of claim 19, wherein setting the gain GupCn at the upper compression threshold THnup comprises setting GupCn to 0 dB for each channel.
